(19) United States
(12) Patent Application Publication
(10) Pub. No.: US 2015/0120553 A1
(43) Pub. Date: Apr. 30, 2015

(54) METHOD AND SYSTEM FOR MAKING MOBILE PAYMENTS BASED ON USER GESTURE DETECTION

(71) Applicant: Tencent Technology (Shenzhen) Company Limited, Shenzhen (CN)

(72) Inventor: Jianli LI, Shenzhen (CN)

(21) Appl. No.: 14/446,238

(22) Filed: Jul. 29, 2014

Related U.S. Application Data
(63) Continuation of application No. PCT/CN2014/078255, filed on May 23, 2014.

(30) Foreign Application Priority Data
Oct. 31, 2013 (CN) 201310530899.3

(51) Int. Cl. G06Q 20/32; H04M 1/725; G06F 3/01

(52) U.S. Cl. CPC G06Q 20/322; G06F 3/017; H04M 1/72583
USPC 705/44

(57) ABSTRACT

The present application relates to a method for making payments using a mobile terminal having one or more processors, memory storing program modules to be executed by the one or more processors, and one or more movement sensors for detecting user gestures of moving the mobile terminal. The mobile terminal receives a payment request from a remote server. In response to the payment request, the mobile terminal detects a gesture motion of the mobile terminal using at least one of the movement sensors and compares the gesture motion with a plurality of predefined gesture motions. If the gesture motion satisfies a predefined mobile payment gesture motion, the mobile terminal then sends an authorization instruction to the remote server. The remote server then arranges a payment to a payee associated with the payment request in accordance with authorization instruction.

### RELATED APPLICATION

This application is a continuation application of PCT Patent Application No. PCT/CN2014/078255, entitled “METHOD AND SYSTEM FOR MAKING MOBILE PAYMENTS BASED ON USER GESTURE DETECTION” filed on May 23, 2014, which claims priority to Chinese Patent Application No. 201310530899.3, entitled “METHOD FOR MAKING PAYMENTS USING A MOBILE TERMINAL BASED ON USER GESTURES AND ASSOCIATED MOBILE TERMINAL,” filed on Oct. 31, 2013, both of which is incorporated by reference in their entirety.

### TECHNICAL FIELD

The present application relates to the electronic technology field and specifically relates to method and system for detecting user gestures and making mobile payments accordingly.

### BACKGROUND

With the rapid development of Internet technology, it has become a convenient and popular payment mode to pay on line by using mobile terminals, such as smart phone (e.g., Android phone, iOS phone, etc.), tablets, palmtop, mobile Internet devices, PAD, etc. However, in the practical application, the user usually needs to manually select the payment mode on the mobile terminal to pay on line when the user uses the mobile terminal to do an on-line payment. It finds in the practical application that, the scheme that the current payment flows need the user to manually select the payment mode makes the payment procedures to be more complex, so as to reduce the efficient of on-line payment; moreover, manual selection payment mode easily results in the private information disclosure such as personal account information in the payment process, reducing the payment safety.

### SUMMARY

The above deficiencies and other problems associated with the conventional approach of making payments using a mobile terminal are reduced or eliminated by the present application disclosed below. In some embodiments, the present application is implemented in a mobile terminal that has one or more processors, one or more movement sensors, memory and one or more modules, programs or sets of instructions stored in the memory for performing multiple functions. Instructions for performing these functions may be included in a computer program product configured for execution by one or more processors.

One aspect of the present application involves a method for making payments using a mobile terminal having one or more processors, memory storing program modules to be executed by the one or more processors, and one or more movement sensors for detecting user gestures of moving the mobile terminal. The mobile terminal receives a payment request from a remote server. In response to the payment request, the mobile terminal detects a gesture motion of the mobile terminal using at least one of the movement sensors and compares the gesture motion with a plurality of predefined gesture motions. If the gesture motion satisfies a predefined mobile payment gesture motion, the mobile terminal then sends an authorization instruction to the remote server. The remote server then arranges a payment to a payee associated with the payment request in accordance with authorization instruction.

Another aspect of the present application involves a mobile terminal including one or more processors; one or more movement sensors; memory; and one or more program modules stored in the memory and to be executed by the one or more processors. The program modules further include instructions for: receiving a payment request from a remote server; in response to the payment request, detecting a gesture motion of the mobile terminal using at least one of the movement sensors; comparing the gesture motion with a plurality of predefined gesture motions; and in accordance with a determination that the gesture motion satisfies a predefined mobile payment gesture motion, sending an authorization instruction to the remote server. The remote server then arranges a payment to a payee associated with the payment request in accordance with authorization instruction.

Another aspect of the present application involves a non-transitory computer-readable storage medium storing one or more program modules to be executed by a mobile terminal having one or more processors and one or more movement sensors. The program modules further include instructions for: receiving a payment request from a remote server; in response to the payment request, detecting a gesture motion of the mobile terminal using at least one of the movement sensors; comparing the gesture motion with a plurality of predefined gesture motions; and in accordance with a determination that the gesture motion satisfies a predefined mobile payment gesture motion, sending an authorization instruction to the remote server. The remote server then arranges a payment to a payee associated with the payment request in accordance with authorization instruction.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

In order to explain the embodiment of the present application and the technical scheme of current technology more clearly, the following will briefly introduce the necessary drawings described in the embodiment or current technology, obviously, the drawings in the following description are only some embodiments of the present application, for the common technicians of this field, they can also obtain other drawings according to these drawings without any creative labor.

FIG. 1 is a schematic flow diagram of a mobile terminal gesture motion analysis control method according to some embodiments of the present application;

FIG. 2 is another schematic flow diagram of a mobile terminal gesture motion analysis control method according to some embodiments of the present application;

FIG. 3 is another schematic flow diagram of a mobile terminal gesture motion analysis control method according to some embodiments of the present application;

FIG. 4 is a schematic diagram illustrating the structure of a mobile terminal according to some embodiments of the present application;

FIG. 5 is a schematic diagram illustrating the structure of a mobile terminal gesture control module according to some embodiments of the present application;

FIG. 6 is a schematic diagram illustrating the structure of a mobile terminal in accordance with some embodiments of the present application;

FIG. 7 is a schematic diagram illustrating the structure of a mobile terminal in accordance with some embodiments of the present application; and

FIGS. 8A to 8F are schematic diagrams of graphical user interfaces supporting mobile payments based on user gestures detected by a mobile terminal according to some embodiments of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The mobile terminals mentioned in the embodiments of the present application may include the mobile devices, such as smart phone (e.g., Android phone, iOS phone, etc.), tablets, palmtop, mobile Internet devices, PAD, or wearable smart devices, etc. Note that a mobile terminal often includes one or more movement sensors, such as the gravity sensor, accelerometer, magnetometer, gyroscopic sensor, etc. Different sensors have different capabilities of detecting the motion or movement of the mobile terminal. For example, the accelerometer senses the orientation of the mobile terminal and then adjusts the mobile terminal's display orientation accordingly, allowing the user to switch between portrait and landscape mode. The gravity or gyroscopic sensor can detect how the mobile device is moved, e.g., its moving speed, moving distance, and moving trajectory, etc. As will be explained below, the mobile terminal held in a user's hand may detect its movement pattern or gesture motion and compare such information with predefined information to determine whether the user intends the mobile terminal to perform a predefined operation (e.g., making a mobile payment authorization). Although the gravity sensor is used below for illustrating the embodiments of the present application, the present application is not limited to the gravity sensor. Similarly, the present application is not limited to mobile payment and it can be used for performing other transactions (e.g., generating a predefined message, e.g., “yes” using a predefined gesture pattern, e.g., drawing a circle) when a user uses the mobile terminal to exchange information with another person.

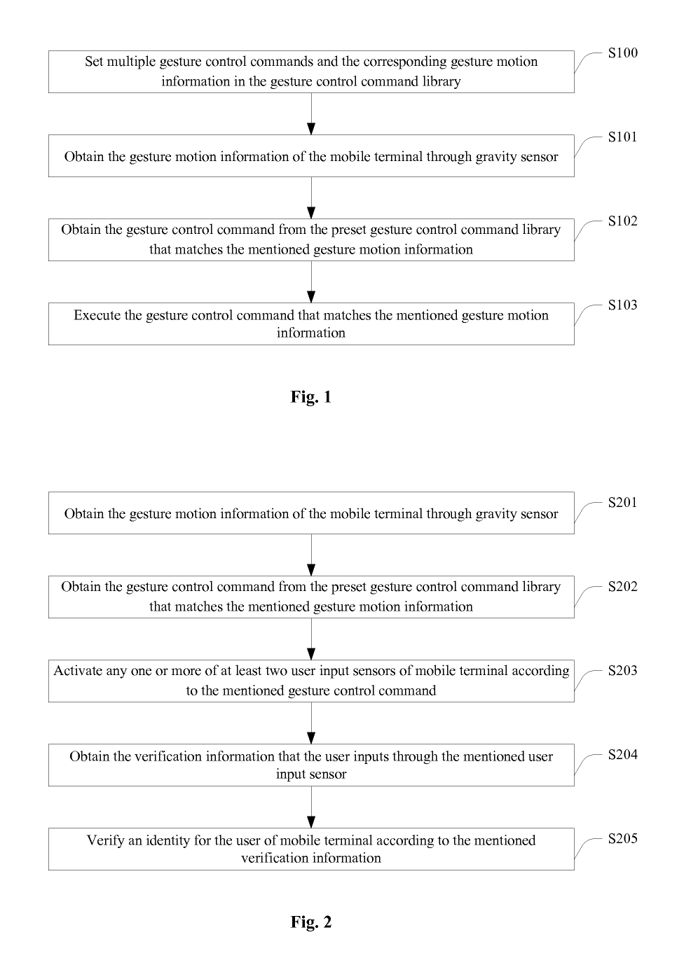

FIG. 1 is a schematic flow diagram of a mobile terminal gesture motion analysis control method according to some embodiments of the present application. As shown in the figure, the gesture motion analysis control method in this embodiment may include the following steps:

S100, the mobile terminal sets multiple gesture control commands and the corresponding gesture motion information in the gesture control command library. In some embodiments, the mobile terminal downloads the multiple gesture control commands from a remote server and stores them in the library or a database at the mobile terminal. In some other embodiments, the mobile terminal has a training mode during which the user can specify what gesture motion triggers which operation. In either case, the user can replace an existing mapping relationship between a gesture motion and a corresponding command with new definitions. This makes it not only more convenient for the user to use the mobile terminal but also more secure if the user feels that the existing mapping relationship between a gesture motion and a corresponding command (e.g., mobile payment) has become known to others.

Specifically, the mobile terminal may preset the gesture control command library in the mobile terminal, the mentioned gesture control command library may include multiple gesture control commands and the corresponding gesture motion information for each gesture control command. In the specific implementation, the mobile terminal may provide multiple optional gesture motion information, for example, shake, swing horizontally, lift up, draw a circle, a triangle or a rectangle and other preset gesture motion. The user may assign these optional gesture motions to the corresponding gesture control commands through the gesture control setting interface, for example, set the gesture motion of shaking the mobile terminal as the gesture control command corresponding to sending the information, set the gesture motion of lifting up as the gesture control command corresponding to receiving the phone call, etc. In some embodiments, the mobile terminal may use the gravity sensor to obtain the gesture motion that the user makes for each gesture control command while holding the mobile terminal in advance and record the gesture motion information corresponding to this obtained gesture control command. For example, the control command of receiving a phone call may be preset as a shaking gesture motion with a first frequency and amplitude, the control command of the control command of hanging up the call may be set as the swing gesture motion with a second amplitude, the control command of the control command of sending message may be set as a gesture motion that draws a circle on a horizontal plane using the mobile terminal, the control command of the control command of opening Wi-Fi function of mobile terminal may be set as a gesture motion that draws a circle on a vertical plane using the mobile terminal, etc. It should be noted that this step is the preparation step of this embodiment. In an optional real-time scenario, the embodiment of the present application may only implement S101-S103 as below.

S101, the mobile terminal obtains the gesture motion information of the mobile terminal through one of the movement sensors, e.g., the gravity sensor.

In the specific implementation, the mobile terminal may detect through the built-in the gravity sensor the gesture motion of the mobile terminal held in the hand of a user. The mobile terminal may obtain the gesture motion information by analyzing the gravity sensor data. The mentioned gesture motion information may include one or multiple of motion direction information, frequency information, speed, and amplitude information of the mobile terminal, for example, the gesture motion of swinging the mobile terminal back and forth and swinging frequency and amplitude, whipping direction and whipping amplitude, track of a specific shape formed by moving, etc.

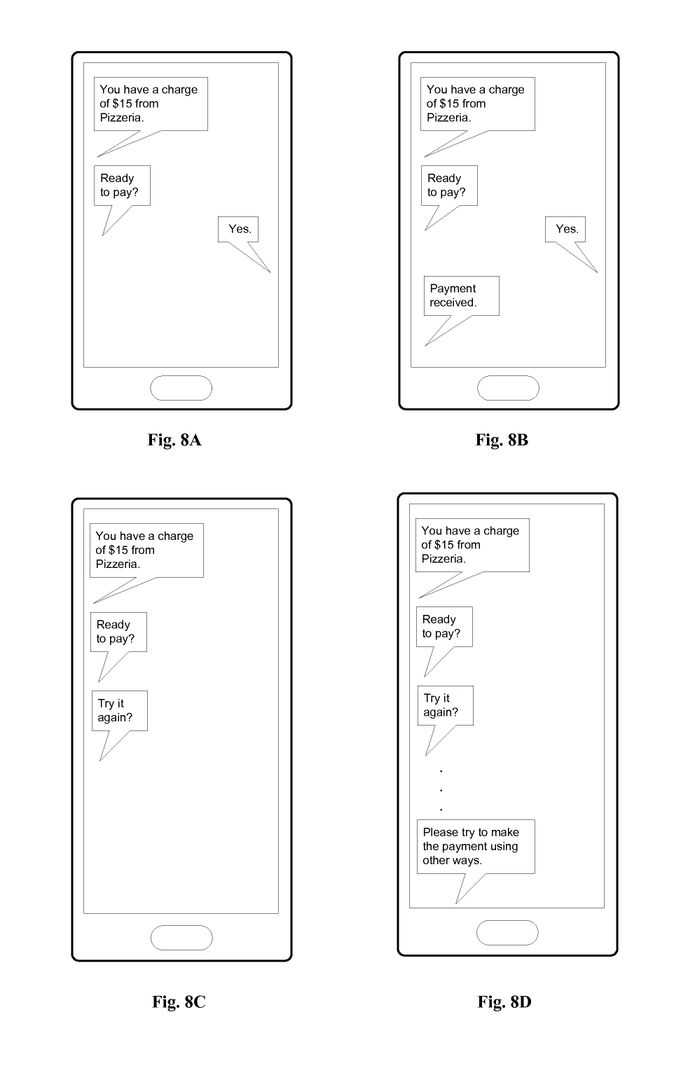

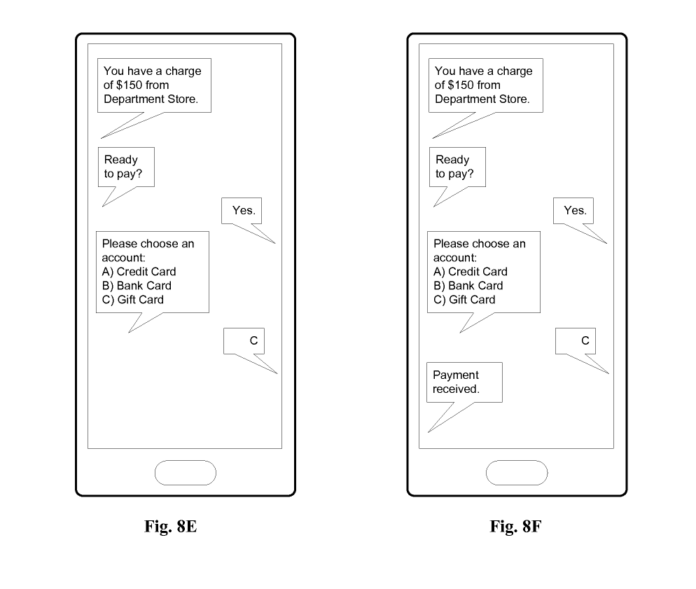

In some embodiments, the mobile terminal detects the gesture motion information after receiving a payment request from a remote server. For example, the user may purchase a meal at a pizzeria as shown in FIG. 8A or check out at a department store as shown in FIG. 8E. In either case, the mobile terminal may display a user identifier (e.g., a 2D bar code) associated with the user and then have it scanned by a scanning device at the pizzeria or department store. The scanning device generates a charge request using the user identifier and sends the charge request to a remote server. The request usually includes the amount of charge against the user and the payee information (e.g., the identity and physical location of the store). Upon receipt of the charge request, the remote server may verify the authenticity of the charge request. For example, the remote server checks whether the mobile terminal is located within proximity of the store and the store is authorized to receive mobile payments from the remote server. After verifying the charge request, the remote server sends a payment request to the mobile terminal. The payment request includes the payee information and the amount of the payment as shown in FIGS. 8A and 8E. In response to the payment request, the mobile terminal starts an application associated with at least one of the movement sensors for detecting the gesture motion caused by the user.

In some embodiments, the mobile terminal specifies a time window (e.g., 1-2 second) after receiving the payment request for detecting the movement of the mobile terminal. In some embodiments, the mobile terminal displays a payment alert message on its display after receiving the payment request. For example, the payment alert message shown in FIG. 8A indicates that the payee is Pizzeria and the amount of payment is $15. Similarly, the payment alert message shown in FIG. 8E indicates that the payee is Department Store and the amount of payment is $150. In some embodiments, the payment alert message includes another message like “Ready to pay?” shown in FIGS. 8A and 8E to start the time window for detecting the gesture motion of the mobile terminal.

S102, the mobile terminal obtains the gesture control command from the preset gesture control command library that matches the mentioned gesture motion information.

In the specific implementation, the mobile terminal may compare the gesture motion information currently obtained with the predefined gesture motion information corresponding to each gesture control command in the mentioned gesture control command library obtained by S101 setting. If the motion movement information currently obtained is satisfies the gesture motion information corresponding to a certain gesture control command in the gesture control command library or if the difference between the two is less than a preset threshold, the mobile terminal may determine that the mentioned gesture control command matches the gesture motion information currently obtained.

S103, the mobile terminal executes the gesture control command that matches the mentioned gesture motion information.

In other words, the mobile terminal executes the corresponding gesture control command according to the detected gesture motion information, which is a new mode of a user inputting the control command to the mobile terminal more conveniently. Note that the relationship between a gesture motion and a corresponding control command may be set/altered by the user, it is hard for somebody else to infer what command the user inputs to the mobile terminal and therefore improves the security and privacy in the process of using mobile terminal to make a mobile payment.

In some embodiments, the mobile terminal sends an authorization instruction to the remote server after determining that the detected gesture motion satisfies a predefined mobile payment gesture option. For example, the user of the mobile terminal may hold the mobile terminal and draw a star shape after receiving the payment request to authorize the remote server to make the payment. As shown in FIGS. 8A and 8E, the mobile terminal generates and displays a payment initiation message “Yes” in connection with sending the authorization instruction. This payment initiation message is to notify the user of the mobile terminal that the user's authorization has been received and processed accordingly. As shown in FIGS. 8A and 8E, the mobile payment transaction may be implemented in an instant messaging application such that the message initiated by the mobile terminal in response to the remote server or the user is displayed on the left side of the screen and the message initiated by the user is displayed on the right side of the screen. This arrangement simulates a dialog between the payee and the user when the user tries to make a payment to the payee in connection with the service received by the user.

In some embodiments, the mobile terminal further displays a payment confirmation message on the display after sending the authorization instruction to the remote server. For example, the mobile terminal may display the confirmation message after receiving a response from the remote server indicating that the mobile payment has been processed as shown in FIG. 8B.

In some other embodiments, the mobile terminal may be configured to display multiple payment options on the display after determining that the gesture motion satisfies a predefined mobile payment gesture motion. As shown in FIG. 8E, the mobile terminal displays three options: A) Credit Card, B) Bank Card, and C) Gift Card after receiving the first gesture motion. In this case, the user has to further specify which option to be used for completing this mobile payment. For example, the user may enter one of the three letters, A, B, or C by hand to select the option for completing the transaction. In some embodiments, the mobile terminal may need to receive a second gesture motion of the mobile terminal using one of the movement sensors. In other words, this second gesture motion provides an additional level of security of preventing any unauthorized payment transactions. For example, the user may flip the mobile terminal twice within a predefined time window. In this case, the mobile terminal converts the flip movement of the mobile terminal into “C,” which indicates that the user prefers to use the third option “C” for making the mobile payment as shown in FIG. 8E. Next, the mobile terminal generates the authorization instruction in accordance with the payment option associated with the second gesture motion and displays a payment confirmation message as shown in FIG. 8F.

In some other embodiments, the mobile terminal may give the user multiple chances of generating the gesture motions to authorize the mobile payment. This is helpful since different gesture motions corresponding to the same movement pattern are not going to be identical and the mobile terminal needs to be fault-tolerant in order to produce a satisfactory result. If the first gesture motion made by the user does not satisfy any predefined mobile payment gesture motions, the mobile terminal may generate and display a message (e.g., “Try it again” as shown in FIG. 8C) prompting the user to generate a new gesture motion within a time window. Note that the new gesture motion may or may not be the same as the first one. In other words, the user can specify that the first gesture motion for authorizing a mobile payment is to draw a circle and the second gesture motion is to draw a number “8”. By doing so, it is more difficult for others to find out what gesture motion is the correct one for authorizing the mobile payment because it is dependent on the sequence of generating the gesture motions. If the user fails to generate the correct gesture motion for a predefined times (e.g., 3-5 times), the mobile terminal may temporarily suspend making any mobile payment as shown in FIG. 8D. In this case, the user may have to reconfigure the gesture motion command library before making any mobile payment. This is a further enhancement of the security of using the gesture motion to make mobile payments. In some embodiments, the correct gesture motion for making mobile payment is time-dependent or location-dependent or both. In this case, the user needs to use the specific gesture motion to be made at a specific location or during a specific time window. This feature can further enhance the security of making the mobile payment using the mobile terminal without having to enter the payment authorization information through a user interface of the mobile terminal.

FIG. 2 is a schematic flow diagram of a mobile terminal gesture motion analysis control method in accordance with some embodiments of the present application. As shown in the figure, the gesture motion analysis control method in this embodiment may include the following steps:

S201, the mobile terminal obtains the gesture motion information of the mobile terminal through the gravity sensor.

In the specific implementation, the mobile terminal may detect through the built-in the gravity sensor that the user holds the mobile terminal to do the gesture motion. The mobile terminal may obtain the gesture motion information by analyzing the gravity sensor data obtained. The mentioned gesture motion information may include any one or multiple information among motion direction information, frequency information and amplitude information of the mobile terminal, for example, swinging back and forth and swinging frequency and amplitude, whipping toward one direction and whipping amplitude, track of a specific shape formed by moving, etc.

S202, the mobile terminal obtains the gesture control command from the preset gesture control command library that matches the mentioned gesture motion information.

Specifically, it may preset the gesture control command library in the mobile terminal, the mentioned gesture control command library may include multiple gesture control commands, and it may set the corresponding gesture motion information for each gesture control command. In the specific implementation, the mobile terminal may provide multiple optional gesture motion information, for example, shake, swing horizontally, lift up, draw a circle and other preset gesture motion, the user may assign these optional gesture motion information to the corresponding gesture control command in the gesture control setting interface, for example, set the gesture of shaking the mobile terminal as the gesture control command corresponding to sending the information, set the gesture of lifting up as the gesture control command corresponding to receiving the phone call, etc. In the subsequent application process, when it obtains the mentioned gesture motion information through the gravity sensor, the mobile terminal may compare the mentioned gesture motion information currently obtained with the gesture motion information corresponding to each gesture control command in the mentioned gesture control command library, if the motion movement information currently obtained is the same with the gesture motion information corresponding to a certain gesture control command in the gesture control command library or meets the similarity of the preset threshold, it may determine that the mentioned gesture control command matches the gesture motion information currently obtained.

S203, the mobile terminal activates any one or more of at least two user input sensors of mobile terminal according to the mentioned gesture control command.

Specifically, in this embodiment, the gesture control command library of mobile terminal preset several gesture control commands therein to respectively build the associated relations with one or more of at least two user input sensors of mobile terminal, for example, gesture control command A corresponds to fingerprint collection sensor of mobile terminal, gesture control command B corresponds to voice print sensor, gesture control command C corresponds to touch screen sensor of mobile terminal, gesture control command D corresponds to fingerprint collection sensor and voice print sensor. After it obtains the gesture control command from the preset gesture control command library that matches with the gesture motion information obtained currently by the gravity sensor, it may open one or more corresponding user input sensors according to the corresponding relation between the preset gesture control command and user sensors. In other optional embodiments, the gesture control command obtained that matches with the gesture motion information may also be verification mode switching command. After it receives this command, the mobile terminal may switch in the optional verification modes, so as to open one or more user input sensor corresponding to the current verification mode.

S204, the mobile terminal obtains the verification information that the user inputs through the mentioned user input sensor(s).

In the specific implementation, if it opens one user input sensor of mobile terminal according to the gesture control command, for example, fingerprint collection sensor, it may obtain the user's fingerprint according to the mentioned fingerprint collection sensor; if it opens more user input sensors according to the mentioned gesture control command, it may obtain the user's fingerprint information respectively according to one or more of mentioned multiple user input sensors, for example, if it opens fingerprint collection sensor and voice print sensor according to the matched gesture control command, it may obtain the fingerprint information and voice print information that user inputs according to the fingerprint collection sensor and voice print sensor opened, respectively.

S205, the mobile terminal verifies the identity for the user of mobile terminal according to the mentioned verification information.

In the specific implementation, it may compare the verification information obtained through the mentioned user input sensor with the preset verification information corresponding to the mentioned user input sensor, of which the mobile terminal may preset the corresponding verification information for each user input sensor, for example, the verification information corresponding to the fingerprint collection sensor may be the fingerprint information that the user pre-inputs and the mobile terminal collects through this fingerprint collection sensor; the verification information corresponding to the voice print sensor may be the voice print information that the user pre-inputs and the mobile terminal collects through voice print sensor; the verification information corresponding to the touch screen input sensor may be the password or screen track graphics and other information that the user pre-inputs through touch screen and the mobile terminal obtains; the verification information corresponding to the keyboard input sensor may be the password or key mapping and other information that the user pre-inputs through the keyboard and the mobile terminal obtains, etc. When it detects that one of user input sensor obtains the verification information that the user inputs, it may compare it with the verification information corresponding to this user input sensor, for example, compare if the input passwords are consistent, or determine if the fingerprint information or voice print information currently obtained meets the approximate degree requirements of the pre-input fingerprint information or voice print information, if yes, it may determine the current user of the mobile terminal is the user with a legal identity, or it may determine that the current user of the mobile terminal is the user identity corresponding to the mentioned verification information according to the successfully compared verification information.

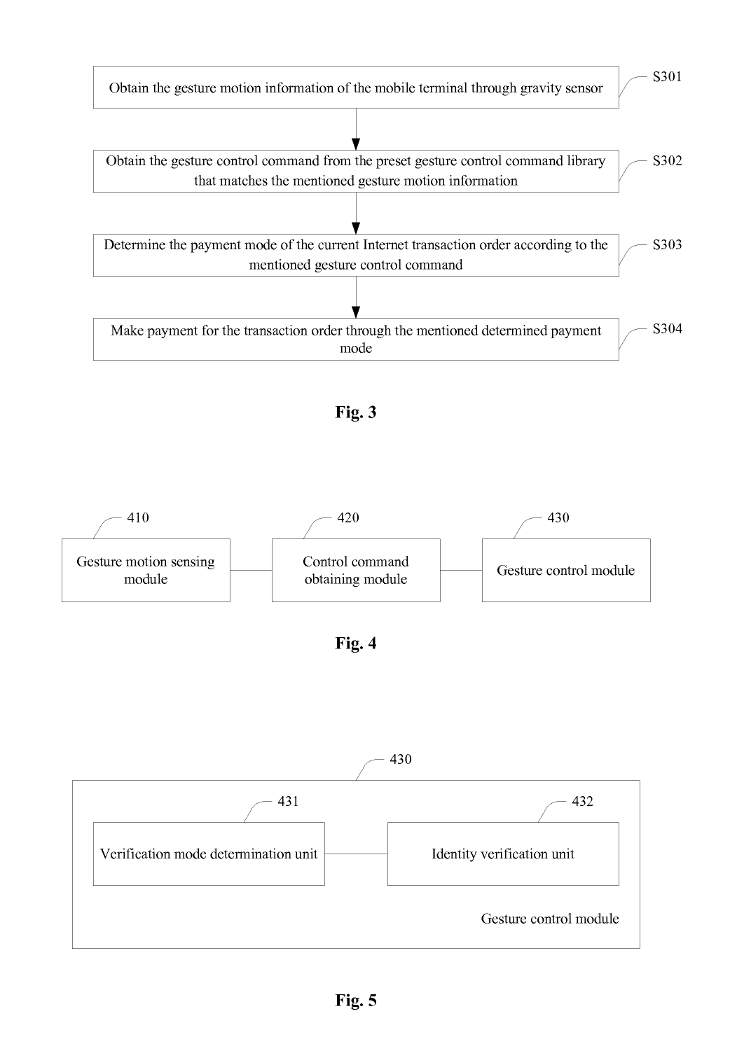

FIG. 3 is a schematic flow diagram of a mobile terminal gesture motion analysis control method in accordance with some embodiments of the present application. As shown in the figure, the gesture motion analysis control method in this embodiment may include the following steps:

S301, the mobile terminal obtains the gesture motion information of the mobile terminal through the gravity sensor. As noted above, the mobile terminal does so in response to receiving a payment request from a remote server.

In the specific implementation, the mobile terminal may detect through the built-in the gravity sensor that the user holds the mobile terminal to do the gesture motion. The mobile terminal may obtain the gesture motion information by analyzing the gravity sensor data obtained. The mentioned gesture motion information may include any one or multiple information among motion direction information, frequency information and amplitude information of the mobile terminal, for example, swinging back and forth and swinging frequency and amplitude, whipping toward one direction and whipping amplitude, track of a specific shape formed by moving, etc.

S302, the mobile terminal obtains the gesture control command from the preset gesture control command library that matches the mentioned gesture motion information.

Specifically, it may preset the gesture control command library in the mobile terminal, the mentioned gesture control command library may include multiple gesture control commands, and it may set the corresponding gesture motion information for each gesture control command. In the specific implementation, the mobile terminal may provide multiple optional gesture motion information, for example, shake, swing horizontally, lift up, draw a circle and other preset gesture motion, the user may assign these optional gesture motion information to the corresponding gesture control command in the gesture control setting interface, for example, set the gesture of shaking as the gesture control command corresponding to sending the information, set the gesture of lifting up as the gesture control command corresponding to receiving the phone call, etc. In the subsequent application process, when it obtains the mentioned gesture motion information through the gravity sensor, the mobile terminal may compare the mentioned gesture motion information currently obtained with the gesture motion information corresponding to each gesture control command in the mentioned gesture control command library, if the motion movement information currently obtained is the same with the gesture motion information corresponding to a certain gesture control command in the gesture control command library or meets the similarity of the preset threshold, it may determine that the mentioned gesture control command matches the gesture motion information currently obtained.

S303, the mobile terminal determines the payment mode of the current Internet transaction order according to the mentioned gesture control command.

Specifically, it is easy to disclose some important private information in the process of using mobile terminal to make an Internet transaction, therefore the gesture control command library of mobile terminal in this embodiment presets some of gesture control command to establish the associated relations with at least one transaction payment mode of mobile terminal, for example, it may make payment by using online bank account a corresponding to gesture control command A; it may make payment by using online bank account b corresponding to gesture control command B; it may make payment by using Alipay account c corresponding to gesture control command C; it may make payment by using TenPay account d corresponding to gesture control command D, etc. In the process that the user uses mobile terminal to conduct Internet transaction, for example, when it determines the payment mode before submitting the order, after it obtains the gesture control command from the preset gesture control command library, which matches with the gesture motion information obtained currently through the gravity sensor, it may determine the payment mode corresponding to the mentioned gesture control command obtained as the payment mode of the current transaction order according to corresponding relation between the preset gesture control command and payment mode. In other optional embodiments, the gesture control command obtained that matches with the gesture motion information may also be payment mode switching command. After it receives this command, the mobile terminal may switch in the optional multiple verification modes, so as to determine one payment mode of which to be the payment mode of the current transaction order.

S304, the mobile terminal makes the payment of the mentioned transaction order through the determined payment mode.

In the specific implementation, the mobile terminal can send the mentioned transaction order to the transaction server or payment server, and the transaction order carries the determined payment mode so as to request the transaction server or payment server to conduct payment processing for the mentioned transaction order.

In the embodiment of the present application, the mobile terminal obtains the gesture motion information through the gravity sensor and determines the payment mode of the current transaction order, consequently avoiding the process of manually selecting the payment mode on the screen of mobile terminal and achieving a safer payment control flow.

FIG. 4 is the schematic diagram illustrating the structure of a mobile terminal in the embodiment of the present application. The mobile terminal in the embodiment of the present application may include the mobile devices, such as smart phone (e.g., Android phone, iOS phone, etc.), tablets, palmtop, mobile Internet devices, PAD, or wearable smart devices, etc. As shown in the figure, the mobile terminal in the embodiment of the present application at least can include:

Gesture motion sensing module 410 is configured for obtaining the gesture motion information through the gravity sensor.

In the specific implementation, gesture motion sensing module 410 may detect through the built-in the gravity sensor that the user holds the mobile terminal to do the gesture motion. The mobile terminal may obtain the gesture motion information by analyzing the gravity sensor data obtained. The mentioned gesture motion information may include any one or multiple information among motion direction information, frequency information and amplitude information of the mobile terminal, for example, swinging back and forth and swinging frequency and amplitude, whipping toward one direction and whipping amplitude, track of a specific shape formed by moving, etc.

Control command obtaining module 420 is configured for obtaining the gesture control command that matches with the mentioned gesture motion information from the preset gesture control command library, and the mentioned gesture control command library includes multiple gesture control commands.

Specifically, it may preset the gesture control command library in the mobile terminal, the mentioned gesture control command library may include multiple gesture control commands, and it may set the corresponding gesture motion information for each gesture control command. In the specific implementation, the mobile terminal may provide multiple optional gesture motion information, for example, shake, swing horizontally, lift up, draw a circle and other preset gesture motion, the user may assign these optional gesture motion information to the corresponding gesture control command in the gesture control setting interface, for example, set the gesture of shaking the mobile terminal as the gesture control command corresponding to sending the information, set the gesture of lifting up as the gesture control command corresponding to receiving the phone call, etc. In the optional embodiment, it may also obtain the gesture motion that the user makes for each gesture control command using the mobile terminal through the gravity sensor in advance and record the gesture motion information corresponding to this obtained gesture control command, for example, the control command of receiving a phone call may be preset as a shaking gesture motion with first frequency and amplitude, the control command of hanging up the call may be set as the swing gesture motion with a second amplitude, the control command of sending message may be set as a gesture motion that draws a circle on a horizontal plane using the mobile terminal, the control command of opening Wi-Fi function of mobile terminal may be set as a gesture motion that draws a circle on a vertical plane using the mobile terminal, etc. In the subsequent application process, when it obtains the mentioned gesture motion information through the gravity sensor, control command obtaining module 420 may compare the mentioned gesture motion information currently obtained with the gesture motion information corresponding to each gesture control command in the mentioned gesture control command library. If the motion movement information currently obtained is the same with the gesture motion information corresponding to a certain gesture control command in the gesture control command library or meets the similarity of the preset threshold, it may determine that the mentioned gesture control command matches the gesture motion information currently obtained.

Gesture control module 430 is configured for executing the gesture control command that matches the mentioned gesture motion information.

In the optional embodiments, as shown in FIG. 5, gesture control module 430 can further include:

Verification mode determination unit 431 is configured for opening any one or more of at least two user input sensors in the mobile terminal according to the mentioned gesture control command, so as to obtain the verification information inputted by the user.

In the specific implementation, the gesture control command library of mobile terminal can preset several gesture control commands therein to respectively build the associated relations with one or more of at least two user input sensors of mobile terminal, for example, gesture control command A corresponds to fingerprint collection sensor of mobile terminal, gesture control command B corresponds to voice print sensor, gesture control command C corresponds to touch screen sensor of mobile terminal, gesture control command D corresponds to fingerprint collection sensor and voice print sensor. After control command obtaining module 420 obtains the gesture control command from the preset gesture control command library that matches with the gesture motion information obtained currently by the gravity sensor, verification mode determination unit 431 may start one or more corresponding user input sensors according to the corresponding relation between the preset gesture control command and user sensors. In other optional embodiments, the gesture control command obtained by control command obtaining module 420 that matches with the gesture motion information may also be verification mode switching command. After received this command, verification mode determination unit 431 may switch in the optional verification modes, so as to start one or more user input sensor corresponding to the current verification mode. if the verification mode determination unit 431 opens one user input sensor of mobile terminal according to the gesture control command, for example, fingerprint collection sensor, it may obtain the user's fingerprint according to the mentioned fingerprint collection sensor; if it opens more user input sensors according to the mentioned gesture control command, it may obtain the user's fingerprint information respectively according to one or more of mentioned multiple user input sensors, for example, if it opens fingerprint collection sensor and voice print sensor according to the matched gesture control command, it may obtain the fingerprint information and voice print information that user inputs according to the fingerprint collection sensor and voice print sensor opened, respectively.

Identity verification unit 432 makes the identity verification for the user of mobile terminal according to the mentioned verification information.

In the specific implementation, identity verification unit 432 may compare the verification information obtained through the mentioned user input sensor with the preset verification information corresponding to the mentioned user input sensor, of which the mobile terminal may preset the corresponding verification information for each user input sensor, for example, the verification information corresponding to the fingerprint collection sensor may be the fingerprint information that the user pre-inputs and the mobile terminal collects through this fingerprint collection sensor; the verification information corresponding to the voice print sensor may be the voice print information that the user pre-inputs and the mobile terminal collects through voice print sensor; the verification information corresponding to the touch screen input sensor may be the password or screen track graphics and other information that the user pre-inputs through touch screen and the mobile terminal obtains; the verification information corresponding to the keyboard input sensor may be the password or key mapping and other information that the user pre-inputs through the keyboard and the mobile terminal obtains, etc. When it detects that one of user input sensor obtains the verification information that the user inputs, it may compare it with the verification information corresponding to this user input sensor, for example, compare if the input passwords are consistent, or determine if the fingerprint information or voice print information currently obtained meets the approximate degree requirements of the pre-input fingerprint information or voice print information, if yes, it may determine the current user of the mobile terminal is the user with a legal identity, or it may determine that the current user of the mobile terminal is the user identity corresponding to the mentioned verification information according to the successfully compared verification information.

The mobile terminal in the embodiment of the present application obtains the gesture motion information of mobile terminal through the gravity sensor and executes the gesture control command matching with it, which can realize a more convenient control command input mode.

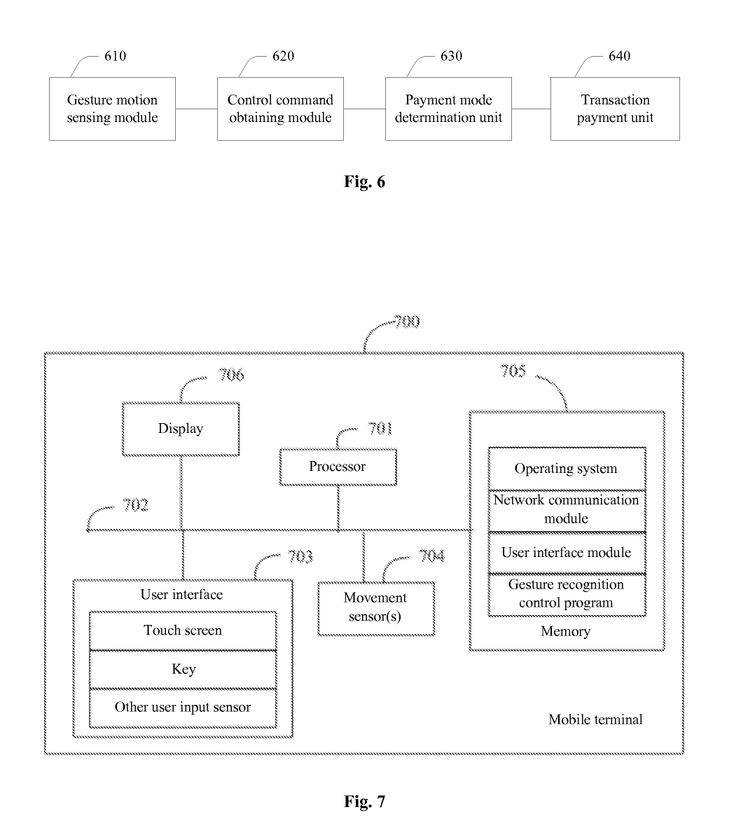

FIG. 6 is the schematic diagram illustrating the structure of a mobile terminal in another embodiment of the present application. The mobile terminal in the embodiment of the present application may include the mobile devices, such as smart phone (e.g., Android phone, iOS phone, etc.), tablets, palmtop, mobile Internet devices, PAD, or wearable smart devices, etc. As shown in the figure, the mobile terminal in the embodiment of the present application at least can include:

Gesture motion sensing module 610 is configured for obtaining the gesture motion information through the gravity sensor.

In the specific implementation, gesture motion sensing module 610 may detect through the built-in the gravity sensor that the user holds the mobile terminal to do the gesture motion. The mobile terminal may obtain the gesture motion information by analyzing the gravity sensor data obtained. The mentioned gesture motion information may include any one or multiple information among motion direction information, frequency information and amplitude information of the mobile terminal, for example, swinging back and forth and swinging frequency and amplitude, whipping toward one direction and whipping amplitude, track of a specific shape formed by moving, etc.

Control command obtaining module 620 is configured for obtaining the gesture control command that matches with the mentioned gesture motion information from the preset gesture control command library, and the mentioned gesture control command library includes multiple gesture control commands.

Specifically, it may preset the gesture control command library in the mobile terminal, the mentioned gesture control command library may include multiple gesture control commands, and it may set the corresponding gesture motion information for each gesture control command. In the specific implementation, the mobile terminal may provide multiple optional gesture motion information, for example, shake, swing horizontally, lift up, draw a circle and other preset gesture motion, the user may assign these optional gesture motion information to the corresponding gesture control command in the gesture control setting interface, for example, set the gesture of shaking the mobile terminal as the gesture control command corresponding to sending the information, set the gesture of lifting up as the gesture control command corresponding to receiving the phone call, etc. In the optional embodiment, it may also obtain the gesture motion that the user makes for each gesture control command using the mobile terminal through the gravity sensor in advance and record the gesture motion information corresponding to this obtained gesture control command, for example, the control command of receiving a phone call may be preset as a shaking gesture motion with first frequency and amplitude, the control command of hanging up the call may be set as the swing gesture motion with a second amplitude, the control command of sending message may be set as a gesture motion that draws a circle on a horizontal plane using the mobile terminal, the control command of opening Wi-Fi function of mobile terminal may be set as a gesture motion that draws a circle on a vertical plane using the mobile terminal, etc. In the subsequent application process, when it obtains the mentioned gesture motion information through the gravity sensor, control command obtaining module 620 may compare the mentioned gesture motion information currently obtained with the gesture motion information corresponding to each gesture control command in the mentioned gesture control command library, if the motion movement information currently obtained is the same with the gesture motion information corresponding to a certain gesture control command in the gesture control command library or meets the similarity of the preset threshold, it may determine that the mentioned gesture control command matches the gesture motion information currently obtained.

Payment mode determination unit 630 determines the payment mode of the current Internet transaction order according to the mentioned gesture control command.

Specifically, it is easy to disclose some important private information in the process of using mobile terminal to make an Internet transaction, therefore the gesture control command library of mobile terminal in this embodiment presets some of gesture control command to establish the associated relations with at least one transaction payment mode of mobile terminal, for example, it may make payment by using online bank account a corresponding to gesture control command A; it may make payment by using online bank account b corresponding to gesture control command B; it may make payment by using Alipay account c corresponding to gesture control command C; it may make payment by using TenPay account d corresponding to gesture control command D, etc. In the process that the user uses mobile terminal to conduct Internet transaction, for example, when it determines the payment mode before submitting the order, after it obtains the gesture control command from the preset gesture control command library, which matches with the gesture motion information obtained currently through the gravity sensor, payment mode determination unit 630 may determine the payment mode corresponding to the mentioned gesture control command obtained as the payment mode of the current transaction order according to corresponding relation between the preset gesture control command and payment mode. In other optional embodiments, the gesture control command obtained by control command obtaining module 620 that matches with the gesture motion information may also be payment mode switching command. After it receives this command, the payment mode determination unit 630 may switch in the optional multiple verification modes, so as to determine one payment mode of which to be the payment mode of the current transaction order.

Transaction payment unit 640 is configured for making payment for the mentioned transaction order through the mentioned determined payment mode. In the specific implementation, transaction payment unit 640 can send the mentioned transaction order to the transaction server or payment server, and the mentioned transaction order carries the mentioned determined payment mode so as to request the transaction server or payment server to conduct payment processing for the mentioned transaction order.

In the embodiment of the present application, the mobile terminal obtains the gesture motion information through the gravity sensor and determines the payment mode of the current transaction order, consequently avoiding the process of manually selecting the payment mode on the screen of mobile terminal and achieving a more safe payment control process.

FIG. 7 is a schematic diagram illustrating the structure of a mobile terminal in accordance with some embodiments of the present application. As shown in FIG. 7, this mobile terminal 700 can include at least one processor 701, for example, CPU, the gravity sensor 704, user interface 703, memory 705, at least one communication bus 702 and display screen 706. Wherein, communication bus 702 is configured for the realization of connection communication among these components. Wherein, user interface 703 may include touch screen, key or other user input sensor; optional user interface 703 may include standard wired interface and wireless interface. Memory 705 may be a high-speed RAM memory, or a non-transitory computer readable storage medium such as non-volatile memory like one disk memory. Memory 705 optionally may be at least one memory device located far away from the aforementioned processor 701. As shown in FIG. 6, as a non-transitory computer memory medium, memory 705 may include:
an operating system that includes procedures for handling various basic system services and for performing hardware dependent tasks,
a network communication module that is used for connecting the mobile terminal 700 to a remote server (not shown) via the one or more communication network interfaces 702 (wired or wireless) and one or more communication networks, such as the Internet, other wide area networks, local area networks, metropolitan area networks, and so on; and
a user interface module for receiving user inputs through the touch screen or other user input sensors; and
a gesture motion analysis control program.

In the mobile terminal 700 shown in FIG. 7, the gravity sensor 704 is configured for sensing the gravity acceleration data of the mobile terminal; the processor 701 may be configured for calling the gesture motion analysis control program stored in the memory 705, processing the obtained gravity acceleration data obtained by the gravity sensor and obtaining the gesture motion information, and executing all or part of flow operation mentioned in the above embodiments in combination with FIGS. 1-3 and 8A-8F, for example, which may include:
Obtain the gesture motion information of the mobile terminal through the gravity sensor.
Obtain the gesture control command that matches with the mentioned gesture motion information from the preset gesture control command library, and the mentioned gesture control command library includes multiple gesture control commands;
Determine the payment mode of the current transaction order according to the mentioned obtained gesture control command;
Make payment for the mentioned transaction order through the determined payment mode.

The mobile terminal in the embodiment of the present application obtains the gesture motion information of mobile terminal through the gravity sensor and executes the gesture control command matching with it, which can realize a more convenient control command input mode.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method for making payments using a mobile terminal, the method comprising:
at a mobile terminal having one or more processors, memory storing program modules to be executed by the one or more processors, and one or more movement sensors:
receiving a payment request from a remote server;
in response to the payment request, detecting a gesture motion of the mobile terminal using at least one of the movement sensors;
comparing the gesture motion with a plurality of predefined gesture motions; and
in accordance with a determination that the gesture motion satisfies a predefined mobile payment gesture motion, sending an authorization instruction to the remote server, wherein the server is configured to arrange a payment to a payee associated with the payment request in accordance with authorization instruction.

2. The method of claim 1, further comprising:
after receiving the payment request from the remote server, displaying a payment alert message on a display of the mobile terminal, the payment alert message further including information about the payee and a payment amount; and
after sending the authorization instruction to the remote sever, receiving a payment confirmation message from the remote server and displaying the payment confirmation message on the display of the mobile terminal.

3. The method of claim 1, further comprising:
after determining that the gesture motion satisfies a predefined mobile payment gesture motion:
displaying multiple payment options on a display of the mobile terminal;
detecting a second gesture motion of the mobile terminal using at least one of the movement sensors;
converting the second gesture motion into one of the payment options; and
generating the authorization instruction in accordance with the payment option associated with the second gesture motion.

4. The method of claim 1, wherein sending the authorization instruction to the remote server further includes:
displaying a payment initiation message on a display of the mobile terminal.

5. The method of claim 1, wherein the gesture motion comprises at least one of movement direction, movement speed, movement amplitude, and movement frequency of the mobile terminal.

6. The method of claim 1, further comprising:
in accordance with a determination that the gesture motion does not satisfy any predefined mobile payment gesture motion:
displaying a message on a display of the mobile terminal, the message prompting a user to generate a new gesture motion of the mobile terminal; and
suspending making payment to the payee associated with the payment request after a predefined number of failures by the user.

7. The method of claim 1, wherein the payment is performed by an instant messaging application running on the mobile terminal.

8. The method of claim 1, wherein the movement sensors comprise at least one of the gravity sensor, accelerometer, magnetometer, and gyroscopic sensor.

9. A mobile terminal, comprising:
one or more processors;
one or more movement sensors;
memory; and
one or more program modules stored in the memory and to be executed by the one or more processors, the program modules including instructions for:
receiving a payment request from a remote server;
in response to the payment request, detecting a gesture motion of the mobile terminal using at least one of the movement sensors;
comparing the gesture motion with a plurality of predefined gesture motions; and
in accordance with a determination that the gesture motion satisfies a predefined mobile payment gesture motion, sending an authorization instruction to the remote server, wherein the server is configured to arrange a payment to a payee associated with the payment request in accordance with authorization instruction.

10. The mobile terminal of claim 9, wherein the program modules further comprise instructions for:
after receiving the payment request from the remote server, displaying a payment alert message on a display of the mobile terminal, the payment alert message further including information about the payee and a payment amount; and
after sending the authorization instruction to the remote sever, receiving a payment confirmation message from the remote server and displaying the payment confirmation message on the display of the mobile terminal.

11. The mobile terminal of claim 9, wherein the program modules further comprise instructions for:
after determining that the gesture motion satisfies a predefined mobile payment gesture motion:
displaying multiple payment options on a display of the mobile terminal;
detecting a second gesture motion of the mobile terminal using at least one of the movement sensors;
converting the second gesture motion into one of the payment options; and
generating the authorization instruction in accordance with the payment option associated with the second gesture motion.

12. The mobile terminal of claim 9, wherein the instruction for sending the authorization instruction to the remote server further comprises instructions for displaying a payment initiation message on a display of the mobile terminal.

13. The mobile terminal of claim 9, wherein the program modules further comprise instructions for:
in accordance with a determination that the gesture motion does not satisfy any predefined mobile payment gesture motion:
displaying a message on a display of the mobile terminal, the message prompting a user to generate a new gesture motion of the mobile terminal; and
suspending making payment to the payee associated with the payment request after a predefined number of failures by the user.

14. The mobile terminal of claim 9, wherein the payment is performed by an instant messaging application running on the mobile terminal.

15. A non-transitory computer-readable storage medium storing one or more program modules to be executed by a mobile terminal having one or more processors and one or more movement sensors, the program modules including instructions for:
receiving a payment request from a remote server;
in response to the payment request, detecting a gesture motion of the mobile terminal using at least one of the movement sensors;
comparing the gesture motion with a plurality of predefined gesture motions; and
in accordance with a determination that the gesture motion satisfies a predefined mobile payment gesture motion, sending an authorization instruction to the remote server, wherein the server is configured to arrange a payment to a payee associated with the payment request in accordance with authorization instruction.

16. The non-transitory computer-readable storage medium of claim 15, wherein the program modules further comprise instructions for:
after receiving the payment request from the remote server, displaying a payment alert message on a display of the mobile terminal, the payment alert message further including information about the payee and a payment amount; and
after sending the authorization instruction to the remote sever, receiving a payment confirmation message from the remote server and displaying the payment confirmation message on the display of the mobile terminal.

17. The non-transitory computer-readable storage medium of claim 15, wherein the program modules further comprise instructions for:
after determining that the gesture motion satisfies a predefined mobile payment gesture motion:
displaying multiple payment options on a display of the mobile terminal;
detecting a second gesture motion of the mobile terminal using at least one of the movement sensors;
converting the second gesture motion into one of the payment options; and
generating the authorization instruction in accordance with the payment option associated with the second gesture motion.

18. The non-transitory computer-readable storage medium of claim 15, wherein the instruction for sending the authorization instruction to the remote server further comprises instructions for displaying a payment initiation message on a display of the mobile terminal.

19. The non-transitory computer-readable storage medium of claim 15, wherein the program modules further comprise instructions for:
in accordance with a determination that the gesture motion does not satisfy any predefined mobile payment gesture motion:
displaying a message on a display of the mobile terminal, the message prompting a user to generate a new gesture motion of the mobile terminal; and
suspending making payment to the payee associated with the payment request after a predefined number of failures by the user.

20. The non-transitory computer-readable storage medium of claim 15, wherein the payment is performed by an instant messaging application running on the mobile terminal.
